(19) United States
(12) Patent Application Publication
(10) Pub. No.: US 2019/0235494 A1
(43) Pub. Date: Aug. 1, 2019

(54) SYSTEM AND METHOD FOR DEFENDING AN UNMANNED AERIAL VEHICLE FROM GROUND THREATS

(71) Applicant: Walmart Apollo, LLC, Bentonville, AR (US)

(72) Inventors: Robert CANTRELL, Herndon, VA (US); Donald R. HIGH, Noel, MO (US); Brian MCHALE, Oldham (GB); Patricia BIRD, Bentonville, AR (US)

(73) Assignee: Walmart Apollo, LLC, Bentonville, AR (US)

(21) Appl. No.: 16/260,838

(22) Filed: Jan. 29, 2019

Related U.S. Application Data
(60) Provisional application No. 62/624,706, filed on Jan. 31, 2018.

(51) Int. Cl. G05D 1/00; G05D 1/04; B64D 1/12; B64C 39/02

(52) U.S. Cl. CPC G05D 1/0055; G05D 1/042; G06K 9/00087; B64C 39/024; B64C 2201/128; B64D 1/12

(57) ABSTRACT

Disclosed herein are systems and methods for defending an unmanned aerial vehicle from threats on the ground. The UAV may perform distracting or deterring measures to prevent the threat from coming into contact with the UAV such as releasing a package attached to the UAV. In other embodiments, the UAV may release a package or cord connected to the UAV if either has been captured by a threat on the ground so that the UAV may escape unharmed.

### BACKGROUND

### 1. Technical Field

The present disclosure relates to unmanned aerial vehicles (UAVs) and more specifically to defending a UAV from threats on the ground.

2. Introduction

The use of UAVs for retail package delivery has become increasingly popular. UAVs have also been used to deliver supplies to places that are not accessible by ground, for example, after a natural disaster. But deploying UAVs in areas populated by people and wildlife presents a number of challenges.

The use of UAVs to deliver packages offers many benefits over traditional package delivery methods. UAVs offer large retailers the ability to deliver packages on-demand with increased automation, minimizing the amount of human capital expenditures and decreasing the impact on the environment that may result from tradition ground transportation. Retail delivery of packages using UAVs requires the vehicles to lower packages to near ground level on property outside of the control of the retailer. When a UAV is close to the ground it is vulnerable to a number of threats that may compromise the UAV itself or the package it contains. For example, domestic or wild animals may mistake a UAV for a predator or prey and may attack the UAV. Another threat that is faced by UAVs is posed by humans that may be innocuously attempting to grab a package or intentionally trying to capture or tamper with the UAV. Additionally, a damaged UAV may be unable to control its landing and may damage property in an uncontrolled landing, such as landing in a flower bed or landing on a pet. The UAV may use a camera, microphone, sensor, or information from a database to determine whether any of the above threats are present in the vicinity of the UAV and determine that a threat condition is present. The presence of a threat condition may initiate the defense measures described herein.

During a package delivery, a UAV equipped with crane and cord may be able to stay a safe distance above ground level. The package may be connected to the UAV via a crane that may raise or lower the package and may be equipped to release the package at the delivery location.

However, a UAV may still be compromised if a downward force is applied to the cord or package attached to the UAV. The UAV may be programmed to rapidly climb when a threat is detected to avoid contact with the threat. In some instances, such as when the UAV has lowered a package, the UAV may not be capable of retracting the cord or climbing rapidly enough to avoid contact. In other instances, the UAV may not detect the threat until after contact with the package or cord has been made, for example, the UAV may not recognize that a person is a threat until after they have grabbed the package or cord. It is therefore advantageous to provide additional defense mechanisms to protect a UAV from damage or capture when it is near the ground, such as during package delivery.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media a technical solution to the technical problem described. In one embodiment the system may comprise an unmanned aerial vehicle; a sensor for sensing a threat to the unmanned aerial vehicle; and a detachment device for detaching an object connected to the UAV when threat condition is met.

In another embodiment a method may comprise detecting a threat in the vicinity of an UAV; determining whether the UAV can avoid the threat; and releasing an object connected to the UAV if the threat cannot be avoided.

In an additional embodiment the system may comprise a sensor for sensing the presence of a person or animal on the ground below an UAV; a processor for determining whether the person or animal is a threat and for determining whether an object may be safely released from the UAV; and a control unit for releasing the object if the person or animal is a threat and the object may be safely released.

### BRIEF DESCRIPTION OF THE DRAWINGS

FIG. 1 is a block diagram of a processing system embodiment;

FIG. 2 is an illustration of an embodiment of the invention in a potential threat situation;

FIG. 3 is an illustration of an example of threat detection;

FIG. 4 is an illustration of an embodiment of the invention in a potential threat situation;

FIG. 5 is an illustration of an embodiment of the invention in a potential threat situation;

FIG. 6 is an illustration of an embodiment of the invention in a potential threat situation;

FIG. 7 is an illustration of a block diagram of an embodiment of the invention.

FIG. 8 is an example method of the invention;

FIG. 9 is an example method of the invention; and

FIG. 10 is an example method of the invention.

### DETAILED DESCRIPTION

UAVs for package delivery may take the form of any of the known unmanned vehicles in the art. The UAV may be fully automated to navigate itself to a specific location or it may be navigated by a person or control program located remotely. The UAV may have a propulsion system, such as an engine and propellers to move through the air. The UAV may have a number of sensors or cameras for monitoring the UAVs surroundings, for example, a UAV may have a GPS device for monitoring its location and a sensor for monitoring people or animals near the UAV. The sensor may include a camera that may be coupled to a processor for monitoring or recording the surroundings of the UAV and for sensing and detecting threats to the UAV. The camera may be monitored by a processor programmed to evaluate threats or it may transmit a feed to a remote location monitored by persons who may be equipped to navigate or direct control of the UAV. The processor may be located at the UAV or remotely coupled to the UAV, for example, by Bluetooth or Wifi. A control unit may be coupled to the processor to control the operation of the UAV. A control unit may also communicate with a remotely located person who may control the vehicle when certain conditions indicate a potential threat situation.

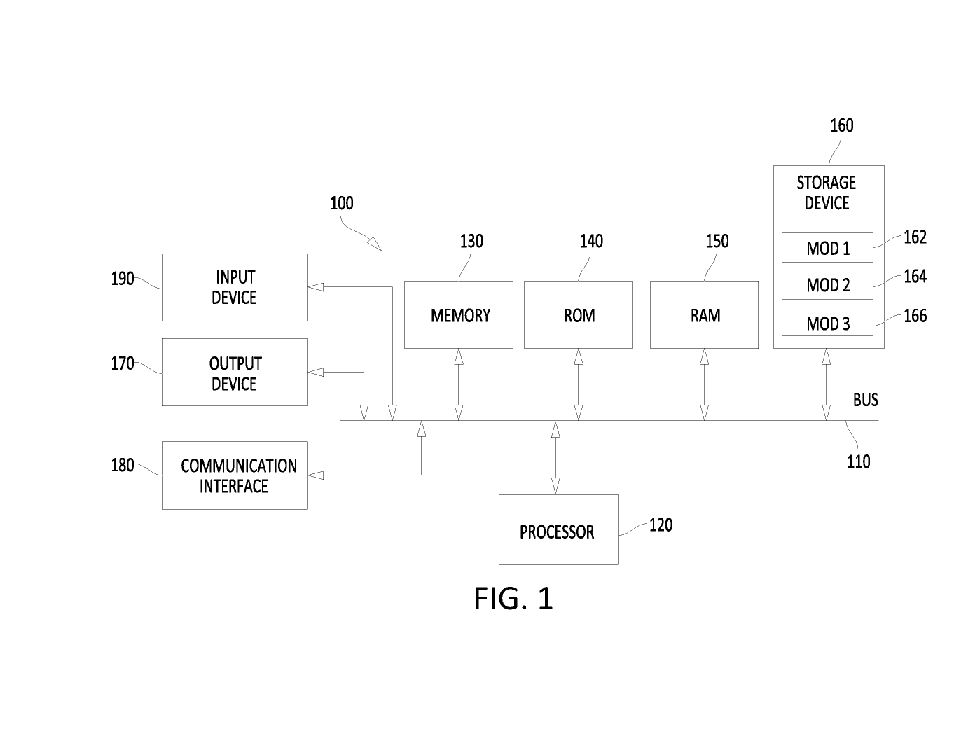

With reference to FIG. 1, an exemplary system includes a general-purpose computing device 100, including a processing unit (CPU or processor) 120 and a system bus 110 that couples various system components including the system memory 130 such as read-only memory (ROM) 140 and random access memory (RAM) 150 to the processor 120. The system 100 can include a cache of high-speed memory connected directly with, in close proximity to, or integrated as part of the processor 120. The system 100 copies data from the memory 130 and/or the storage device 160 to the cache for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer-readable storage media provide nonvolatile storage of computer-readable instructions, data structures, program modules and other data for the computing device 100. In one aspect, a hardware module that performs a particular function includes the software component stored in a tangible computer-readable storage medium in connection with the necessary hardware components, such as the processor 120, bus 110, display 170, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 100 is a small, handheld computing device, a desktop computer, or a computer server.

Although the exemplary embodiment described herein employs the hard disk 160, other types of computer-readable media which can store data that are accessible by a computer, such as magnetic cassettes, flash memory cards, digital versatile disks, cartridges, random access memories (RAMs) 150, and read-only memory (ROM) 140, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

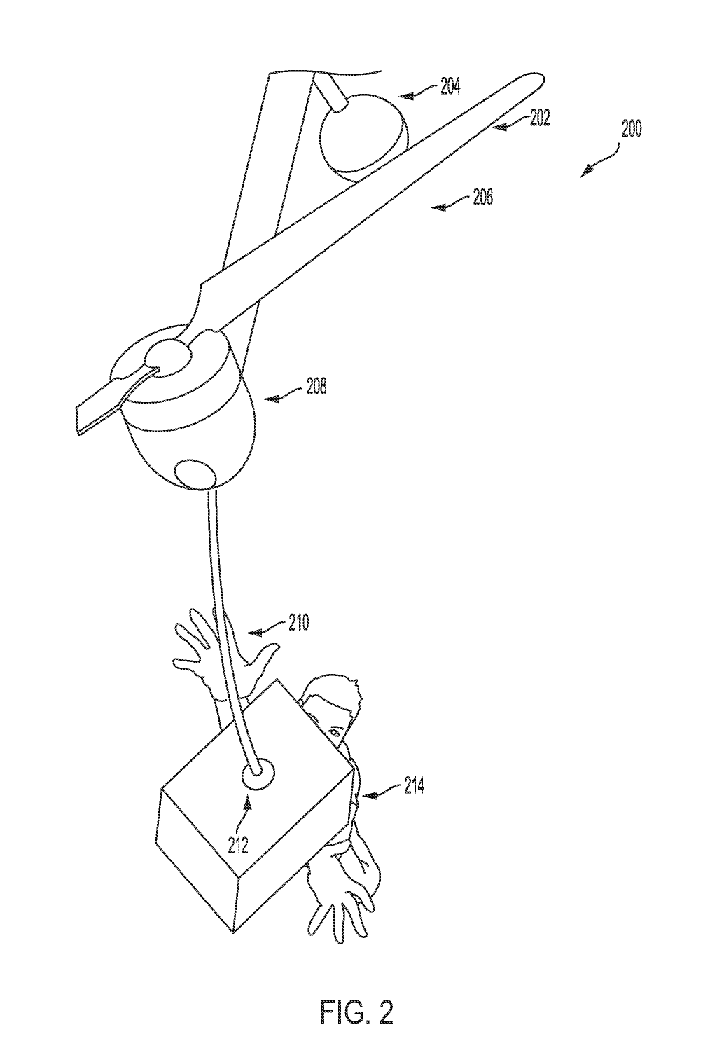

An embodiment of a UAV for package delivery is depicted in FIG. 2. System 200 may include a crane 208 that is coupled to the lifting apparatus 202 of the UAV 206. For example, a crane 208 or wench for raising and lowering a cord 210 may be attached to the UAV 206. In one application, a package 214 may be attached to the cord 210 via a securing mechanism 212, such as a claw or magnet, at a warehouse. The securing mechanism may operate in two modes, the first mode may secure the package to the UAV and the second mode may release the package from the UAV. In one example the package 214 may first be secured to the cord 210 at a warehouse, the cord 210 may be retracted by crane 208 into the UAV 206, the UAV 206 may then navigate to a delivery destination, the crane 208 may lower the package 214 to or near the ground, and the package 214 may be released by the securing mechanism 212 at the delivery location. The package 214 may be released in response to an intended recipient being detected or making contact with the package 214. The package 214 may also be prevented from being released when a non-intended recipient or other obstacle is detected on the ground or at or near the delivery destination. The UAV 206 may prevent a non-intended recipient or other threat from obtaining the package 214 by rapidly rising in altitude until the threat passes.

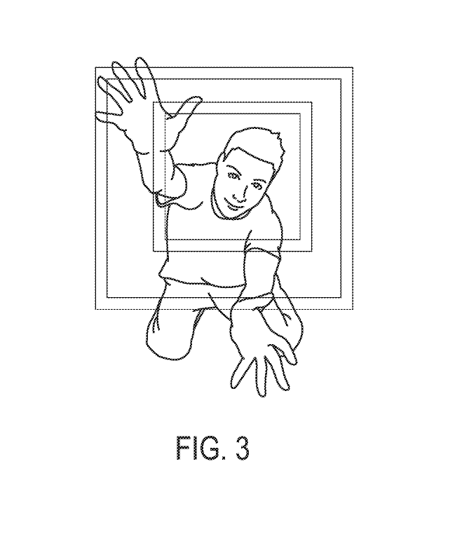

A UAV 206 may be equipped with a sensors 204, which may include a camera, for detecting a threat, such as a person reaching for the UAV 206 or a package attached to the UAV 206. The sensor 204 or camera may be programmed to automatically detect objects, people, or animals and determine whether they pose a threat to the UAV 206. In embodiments wherein the sensor includes a camera, an image or video feed such as that depicted in FIG. 3 may be transmitted to a remote location. The image may be evaluated by a remotely located person or using image identifying software. In some embodiments, facial recognition software may be used to determine if the personal or animal attempting to make contact with the package is the intended recipient. If it is determined that the image depicts the intended recipient the UAV may release the package. If the image does not depict the intended recipient, the UAV may retain the package and leave the area. In other embodiments, the UAV may hover until the intended recipient is identified and then release the package. For example, if the image depicts a child, the UAV may retain the package and stay a distance from the child. But if the image depicts the intended recipient, the system may lower the package to a distance within reach of the recipient and the package may be released when it is in the hands of the intended recipient. The system may include one or more force sensors for sensing the force exerted by the package on the UAV. In some embodiments, a change in the force may indicate that the package is in the hands of the recipient.

In other embodiments the intended may have a key to identify themselves as the intended recipient. The key may be an image, password, or sound that may be evaluated by the processor and the personal or animal attempting to make contact with the package may not be deemed a threat if the key matches the key known to the processor. In other embodiments the key may be a radio pulse that may be received by the antennas attached to the UAV. This system may employ any of the smartkey technology known in the art.

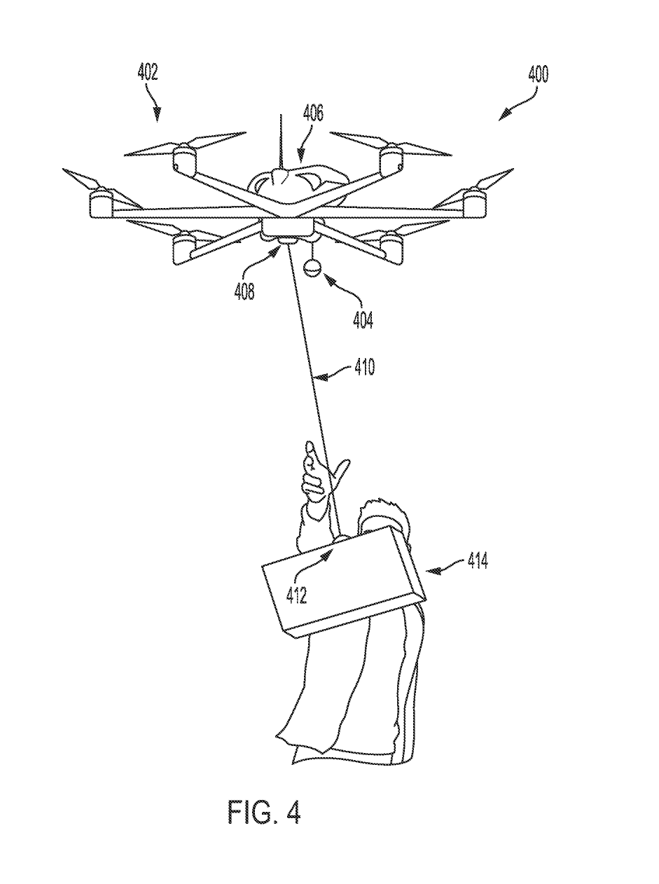

For example, as shown in FIG. 4, the processor may analyze one or more images and detect that a person is attempting to grab the package 414 or the cord 410. The sensor 404 may also provide information to a remote individual or processor that may analyze the footage or sensor output as it is received and determine whether a threat is present. The crane 408 may include a force sensor for sensing the force applied by the cord 410 on the crane 408. The securing mechanism 412 may also include a sensor for the sensing the force applied by the package 414 on the securing mechanism 412. In these embodiments, a threat may also be detected if the force sensor senses excessive force being applied to the crane 408 or securing mechanism 412 which may indicate that a person or animal has grabbed the package 414 or cord 410.

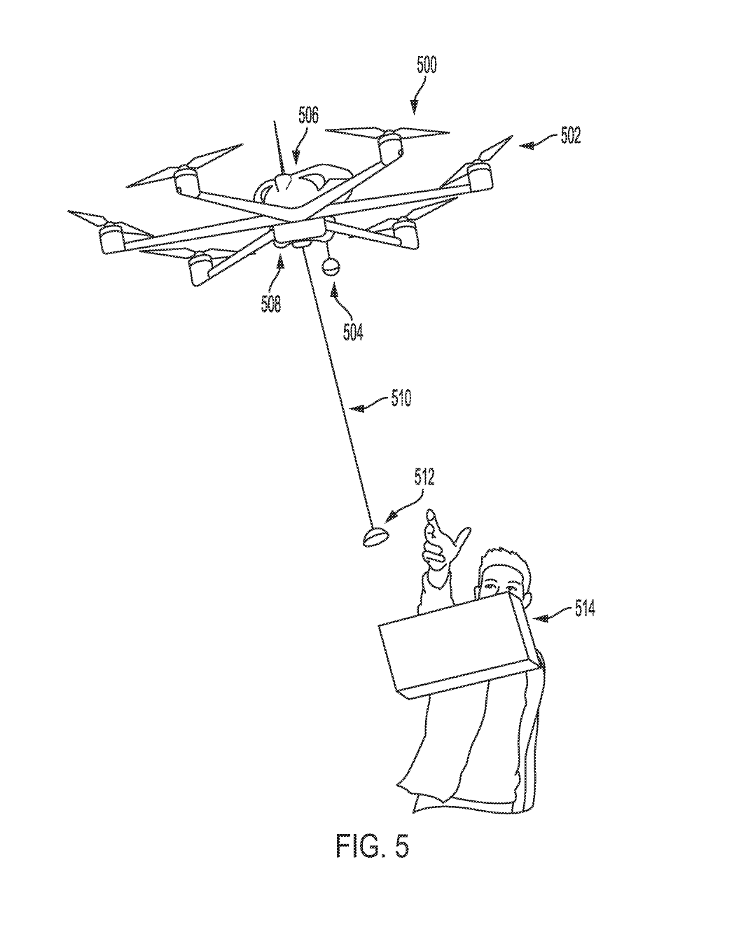

In one embodiment, the UAV 406 or processor coupled to the UAV 406, may detect a threat such as a person or animal reaching for or grabbing the package while it is still attached to the cord 410 and crane 408 as shown in FIG. 3. If the threat is able to grab the package while it is still connected to the cord 410 and crane 408, the person may intentionally or innocuously apply a force to the UAV 406 that may cause damage to the UAV 406, allow the UAV 406 to be captured, or cause it to lose control-risking injury to the threat, other people, animals, or property on the ground. Therefore, in an embodiment shown in FIG. 5, the securing mechanism 512 may release the package 514 from the UAV when a threat is detected. The package 514 may be released to startle the threat to prevent it from making contact with the package 514 while it is attached to the crane 508 and the UAV and to give the UAV time to exit the zone of contact. If the threat has already made contact, the package 514 may be released to free the UAV from the compromised package so that it can climb and escape damage or capture.

In other embodiments, the sensors may communicate to the processor whether there had been a negative or positive change in the force on the securing mechanism. A negative force may indicate that a person has made contact with the package, lessening the downward force applied to the securing mechanism. A positive force may indicate that a threat or non-intended recipient has made contact with the package. A negligible change in the force applied to the securing mechanism may indicate that the intended recipient has not made contact with the package.

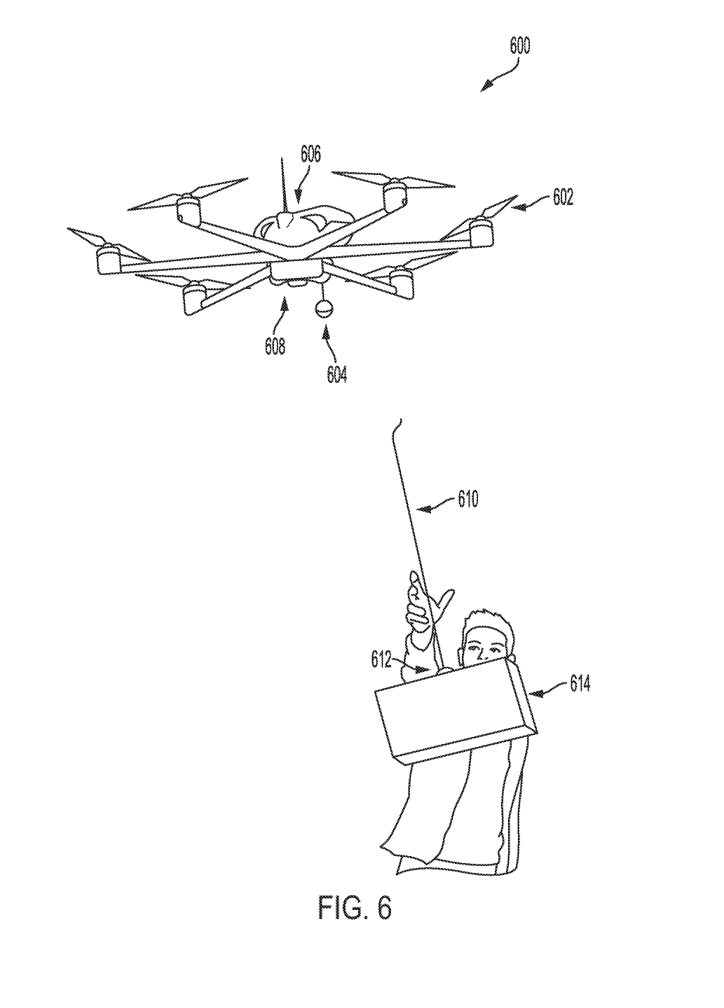

In other embodiments, the threat may make or attempt to make contact with the cord attached to the crane, such as in FIG. 4. In these embodiments, as depicted in FIG. 6, the crane 608 may release the cord 610 and the package 614 to avoid damage to the UAV 606. The cord 610 may be unspooled so that it drops off of the UAV. In other embodiments, the slack of the cord 610 may be allowed to fall freely so that the UAV is not effected by any downward force applied to the cord 610 or package 614. Such embodiments may be advantageous where the threat is not intending to capture or tamper with the UAV but simply trying to retrieve the package. In some embodiments securing mechanism 612 or crane 608 may be programmed or designed to release if a threshold force is applied to the package 614 or the cord 610. For example, if the force on the package is stronger that the force necessary for the UAV to climb using propellers 602, the mechanism may release the package 614 or cord 610.

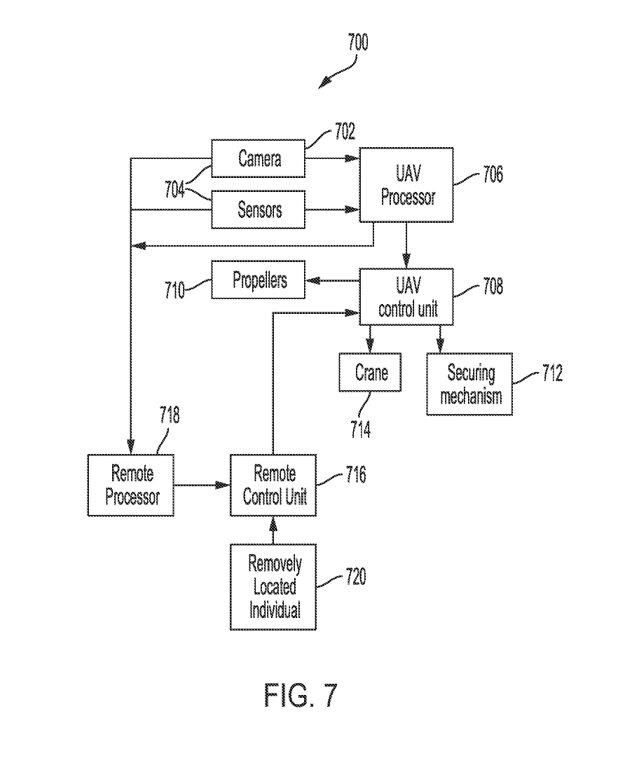

FIG. 7 is a block diagram of an example embodiment 700. System 700 may have a camera or other sensors 704 communicatively coupled to a UAV processor 706 located on or in the UAV and to a remotely located remote processor 718. The remote processor 718 may determine whether a threat or an intended recipient is attempting or at risk of contacting the package. In some embodiments the remote processor 718 may determine the nature of the threat. In still further embodiments the remote processor may determine the appropriate action to take based on the input from the camera or sensors 704. Remote processor 718 is communicatively couple to remote control unit 716 which may additionally receive information from a remotely located individual 720 that may monitor the feed from camera and sensors 704 or other operating conditions of the UAV. In some embodiments, the remotely located individual 720 may navigate the UAV or monitor its geographic location. The remote control unit 716 may receive operating commands from the remote processor 718 and/or the remotely located individual 720. Remote control unit 716 may then transmit these commands to UAV control unit 708. UAV control unit 708 may then control various operating conditions of the UAV, for example, the operation of the propellers 710, the raising and lowering of the crane 714, or the operation of the securing mechanism 712. The various remote capabilities may also be performed in the UAV.

In an example embodiment, the securing mechanism may release the package when a force sensor determines that the force applied to the securing mechanism by the package is above a first securing mechanism force threshold. The first securing mechanism force threshold may be determined by a processor that may control the securing mechanism or may respond to user input or other variables, such as the weight of the package. In some embodiments the first securing mechanism force threshold may also consider the direction that the UAV is traveling, for example, if the UAV is raising or lowering altitude, the chance of force may be considered in this determination. The first securing mechanism force threshold may be an amount of force indicative of a threat being in contact with the package. For example, if the force on the securing mechanism exceeds a value that is attributable to the weight of the package, it may indicate that a person or animal has grabbed the package and the securing mechanism may release the package. If the force being applied to the crane by the cord is above a second threshold, it may indicate that a person or animal has grabbed the cord the crane may release the cord. The second threshold may be higher than the first threshold so that the package can be released under appropriate conditions without releasing the cord. In some embodiments, the securing mechanism and/or crane may be designed so that it cannot withstand force above a certain level and will release the package or cord when force above that level is applied, this level may be the amount of force that would prohibit the UAV from effectively navigating or rising in altitude. This may be fully mechanical and the components may be designed to release or break at a threshold force less than that which may prevent the UAV from climbing. In other embodiments, the processor may detect excessive force on the crane and securing mechanism in a first step. In a second step the sensors, such as the camera, on the UAV may be used to determine if the force is being asserted by a threat. If the detected force is not determined to be threatening based on the input from the sensor or camera, the processor may determine not to release the package and/or cord.

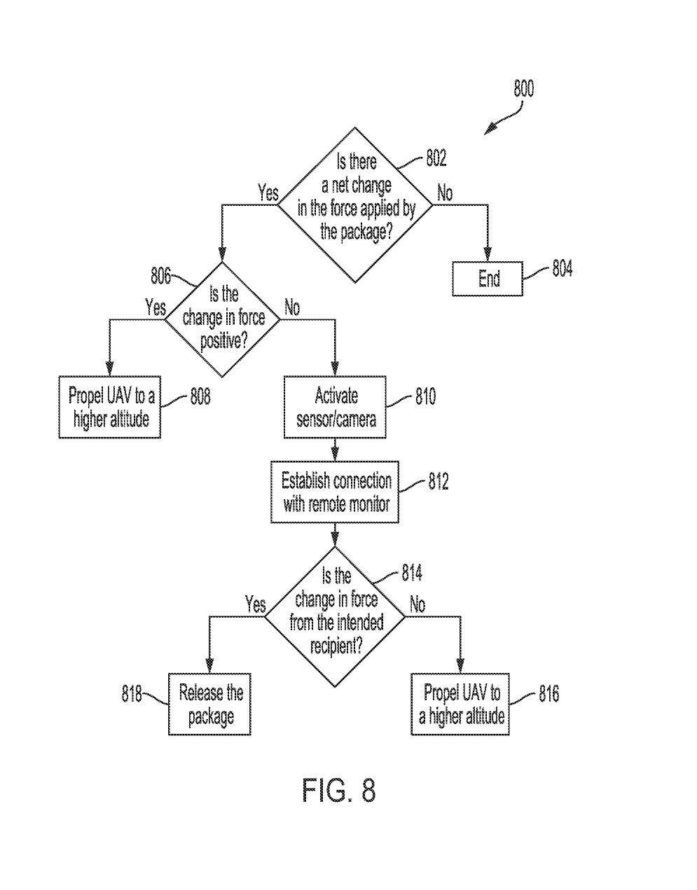

FIG. 8 depicts a flowchart of an example operating method of the UAV. The method 800 determines whether there is a net change in the force exerted by package at 802. This determination may be made using a sensor or camera located at the securing mechanism, at the crane, or a combination thereof. If there is no change in the force exerted by the package the method ends at 804. If there is a net change on the force exerted by the package, the method determines if the change in force is positive or negative at 806. If the change in force is positive, the method may determine that the intended recipient has not made contact with the package and the UAV may rise to a higher altitude at 808. In some embodiments the UAV may return with the package to a designated location, such as a secure waiting location or back to a warehouse. In further embodiments the UAV may hover above the destination and attempt delivery at a later time.

If the sensor determines the change of force applied by the package is negative, this may indicate that the package has made contact with the intended recipient. If this determination is made the method may activate a sensor or camera at 810. At 812 the sensor or a processor coupled to the sensor may establish connection with a remotely located individual or remotely located processor. At 814, the remotely located individual or processor may analyze the video feed, image, or other sensor output and determine if the intended recipient has made contact with the package. If the intended recipient has made contact with the package, the securing mechanism may release the package at 818. In some embodiments, the package will be released into the intended recipient's hands. In still further embodiments the intended recipient may be a storage location such as a porch or secure storage locker. If at 814, it is determined that the change in force was not cause by the intended recipient, the UAV 816 may rise to a higher altitude or perform any of the defensive operations described herein.

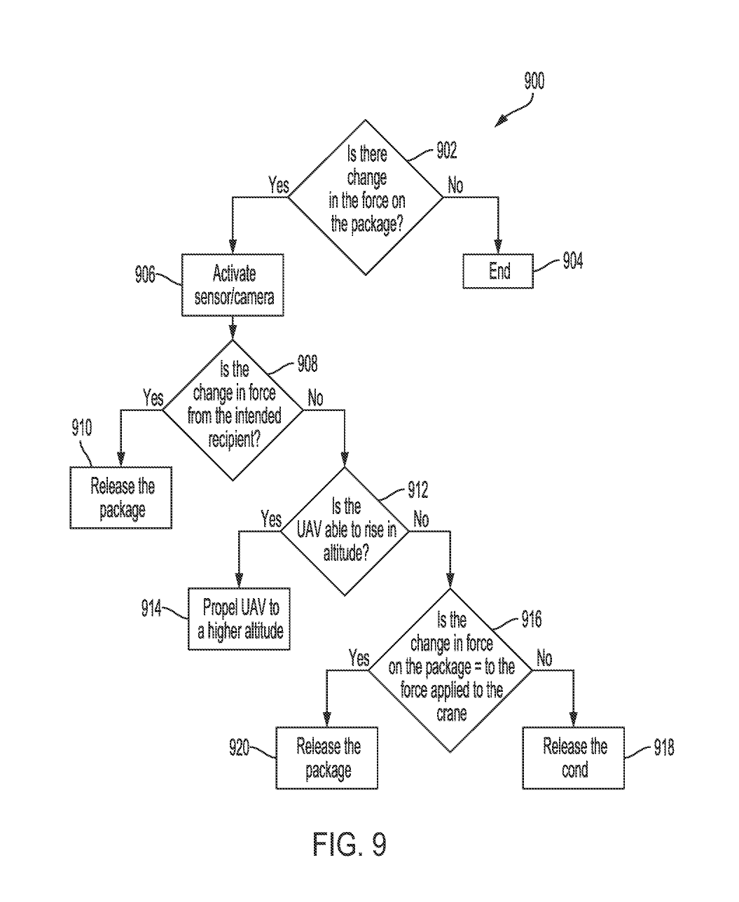

FIG. 9 depicts a flowchart of another example operating method of UAV 900. At 902 the method determines if there is a change in net force exerted on the UAV from the package. If there is no change in force the method ends at 902. If there is a change of force from the package, the method activates a sensor or camera at 906. If no change in force is detected the method may end at 904. At 908 the method determines whether the change of force is a result of the intended recipient making contact with the package using output from the sensor or camera. If the intended recipient has made contact with the package the securing mechanism may release the package at 910.

If a change in force is not from the intended recipient, the method may determine whether the UAV can rise in altitude at 912. If the UAV is able to rise in altitude, it is propelled to a higher altitude at 914. If the UAV is not able to rise in altitude, the method may compare the force on the crane to the force on the securing mechanism at 916. If the force on the securing mechanism is equal to or near the force on the crane, the method may release the package from the securing mechanism at 920. If the force on the crane is not equal to the force on the securing mechanism, the method may release the cord from the UAV at 918.

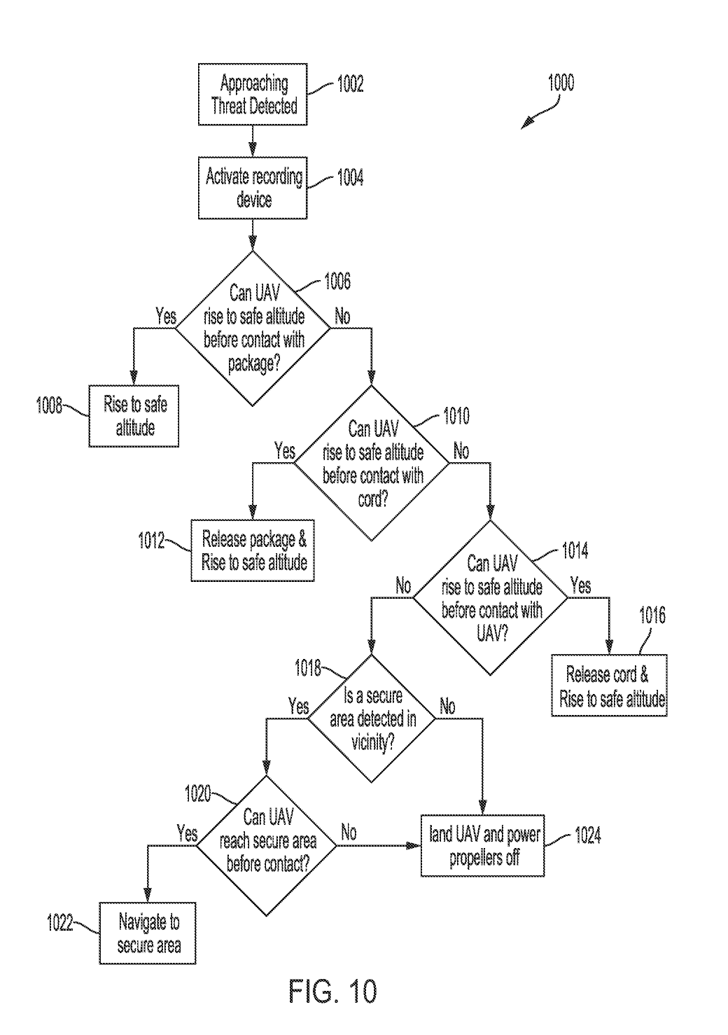

FIG. 10 depicts a flowchart of another example operating method of a UAV 1000. At 1002 the system may determine that a threat is approaching the UAV or that the UAV is in a threat condition. At 1004 a recording device may be activated. At 1006, the processor may determine whether the UAV can climb a safe altitude in time to avoid the threat from coming into contact with the package. The processor may determine the distance of the threat to the package and the rate that the threat is approaching to determine the amount of time the UAV has until contact is made. The processor may then compare this with the rate at which the UAV can climb to a safe altitude. If the cord is extended, the processor may also consider the rate at which the cord may be retracted by the crane. In some embodiments the safe altitude may be determined based on the threat, such as the height of the threat, or whether the cord is extended. If the UAV can rise to a safe altitude it will rise to that altitude at 1008. If the UAV cannot rise to a safe altitude the processor may determine whether it can rise to a safe altitude before the threat can make contact with the cord at 1010. If the UAV can rise to a safe altitude the method may release the package and rise to the safe altitude.

If the UAV cannot rise to a safe altitude before contact is made with the cord at 1010, the method may determine whether the UAV can rise in altitude before the threat can make contact with the body of the UAV at 1014. If the UAV can rise to a safe altitude in time to avoid contact, the method may release the cord at and rise to the safe altitude at 1016.

If the UAV cannot rise to a safe altitude before the threat can make contact, the processor may determine whether a secure area is detected at 1018. I secure area may be beyond a physical barrier such as a fence, a populated area, or an area under surveillance. The presence of a secure area may be made by the processor using sensors, information from a database, or by an individual monitoring the UAV remotely. At 1020 the processor may determine whether the UAV can reach the secure area before the threat can make contact with the UAV. If the UAV cannot reach the secure area in time to escape the threat or if no safe area is detected, the UAV may land and the propellers may be turned off. This may be advantageous to avoid damage to the UAV, the threat, or other objects on the ground. In still further embodiments the UAV may activate a compromise mode, the compromise mode may activate an alarm, a GPS or radio beacon, or lock or destruct the software and/or hardware to prevent the use of the UAV by an unauthorized individual or to prevent access to the larger system to which the UAV is communicatively coupled. If the UAV can reach the secure area at 1020, the UAV will navigate to the secure area at 1022.

In other embodiments, if it is determined that the UAV cannot climb to a safe altitude in time, the processor may determine what evasive maneuver to take. If the processor determines that the proper evasive maneuver is to release the package, then the securing mechanism may release the package. This determination may be made if it determined that the package is at a height that will not cause injury to the threat or damage the contents of the package or anything else on the ground such as people. In other embodiments, the processor may determine that the threat is a person attempting to pull the UAV down, the processor may then determine that it is appropriate to release the package to startle the threat but still allow the person to catch the package without injury. The processor may determine whether the UAV is in a safe release zone, which may be based on the location or classification of the threat or the altitude of the package. The classification of the threat may for example, be whether the threat is intentionally or incidentally posing a threat to the package or UAV, or whether the threat is an animal, child, or adult. The safe zone may be used to determine whether releasing the package could cause injury to person or things below. If the processor determines that the threat is an animal, the processor may chose not to release the package and perform a different evasive maneuver to avoid injuring the animal. In other embodiments the UAV may release the cord and the package. For example, if the threat has grabbed or made contact with the cord or the securing mechanism, the UAV may release the cord from the crane entirely.

In still further embodiments, the processor may determine that a force on the UAV cannot be overcome or cannot be overcome without damage to the UAV or risk to people or property on the ground. For example, if the force causes the UAV to lose control or rendered it no longer flightworthy, the processor may determine that it is appropriate to land the UAV in such a way as to minimize damage to the UAV, the package, or anything in the vicinity of the UAV. For example, if an animal has captured the package or cord while it is still attached to the UAV, and the UAV is unable to climb, the UAV may land itself. In other embodiments, a remotely located individual or computer may take control of the UAV and navigate a landing in a way that minimizes harm to the UAV or persons or objects on the ground. For example, the UAV may navigate so that it does not injure the animal, land in a flower bed, or fly into the traffic. In some embodiments, the system may alert a processor located at a remote location if a threat is detected and the remote processor may take over navigation. In other embodiments, the UAV may alert a remotely located person of a threat and the person may use the camera to determine the proper evasive maneuver or manually navigate the UAV. An evasive maneuver may include both vertical and horizontal movements to quickly dodge the grasp of an animal or person. In still further embodiments, the UAV may begin recording information from the sensors or feed from the camera so that the location and identity of the threat is stored. For example, if a person attempts to grab the UAV, the UAV may indicate that the footage from the camera should be transmitted to a remote location and stored so that the person may be identified.

In still further embodiments the UAV may perform a distracting or deterring action when a threat is recognized and there is insufficient time to climb out of the zone of danger. As discussed above, the distraction may be releasing the package. The UAV may have a pre-programmed or calculable maximum height of release so that, at any point below that height, the UAV may release the package. This height may be determined by the danger to those on the ground, the area of delivery (i.e. rural or urban), or the contents of the package (i.e. fragile or sturdy). In still further embodiments, the distraction may consist of an alarm that may sound if a threat is detected. In still further embodiments, the UAV may be equipped with a physical deterrent, such as a liquid or gas, which may be released if a threat is detected to deter the threat or distract the threat so that the UAV has enough time to escape the zone of contact. In some embodiments the liquid or gas may include an irritant, such as pepper spray.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

1. A system comprising:
an unmanned aerial vehicle;
a crane attaching the unmanned aerial vehicle to a cord;
a securing mechanism for attaching the cord to a package;
a sensor attached to the unmanned aerial vehicle for sensing a threat to the unmanned aerial vehicle;
a processor communicatively coupled to actuators of the unmanned aerial vehicle for releasing the package when a threat condition is detected.

2. The system of claim 1, wherein the cord can be detached from the crane.

3. The system of claim 1, wherein the cord is retractable.

4. The system of claim 2, wherein the actuators can cause the crane to release the cord.

5. The system of claim 1, wherein the actuators can cause the securing mechanism to release the package.

6. The system of claim 1, wherein the threat is a force applied to the package being above a threshold.

7. The system of claim 1, wherein the sensor is a camera.

8. The system of claim 1, wherein the detachment device is a claw or a magnet.

9. A method comprising:
detecting a threat in the vicinity of an unmanned aerial vehicle;
determining whether the unmanned aerial vehicle can avoid the threat; and
releasing an object connected to the unmanned aerial vehicle if the threat cannot be avoided.

10. The method of claim 9, further comprising determining whether the unmanned aerial vehicle is within a safe dropping distance from the ground.

11. The method of claim 9, further comprising identifying whether the threat is a person or an animal.

12. The method of claim 9, further comprising performing an evasive maneuver if the unmanned aerial vehicle can avoid the threat.

13. The method of claim 12, wherein the evasive maneuver comprises climbing in altitude.

14. The method of claim 12, wherein the evasive maneuver is retracting a cord attached to the unmanned aerial vehicle.

15. The method of claim 12 wherein the object is a package connected to the unmanned aerial vehicle.

16. (canceled)

17. (canceled)

18. (canceled)

19. (canceled)

20. (canceled)
